(19) United States
(12) Patent Application Publication
(10) Pub. No.: US 2019/0065384 A1
(43) Pub. Date: Feb. 28, 2019

(54) EXPEDITING CACHE MISSES THROUGH CACHE HIT PREDICTION

(71) Applicant: QUALCOMM Incorporated, San Diego, CA (US)

(72) Inventors: Rami Mohammad AL SHEIKH, Morrisville, NC (US); Shivam PRIYADARSHI, Morrisville, NC (US); Brandon DWIEL, Jamaica Plain, MA (US); David John PALFRAMAN, Raleigh, NC (US); Derek HOWER, Durham, NC (US)

(21) Appl. No.: 15/683,350

(22) Filed: Aug. 22, 2017

(51) Int. Cl. G06F 12/0875; G06F 12/084; G06F 12/0811

(52) U.S. Cl. CPC G06F 12/0875; G06F 12/084; G06F 2212/62; G06F 2212/60; G06F 12/0811

(57) ABSTRACT

A request to access data at a first physical address misses in a private cache of a processor. A confidence value is received for the first physical address based on a hash value of the first physical address. A determination is made that the received confidence value exceeds a threshold value. In response, a speculative read request specifying the first physical address is issued to a memory controller of a main memory to expedite a miss for the data at the first physical address in a shared cache.

### BACKGROUND

Aspects disclosed herein relate to processing systems which implement speculative memory operations. More specifically, aspects disclosed herein relate expediting cache misses through cache hit prediction.

Modern computing systems may include multiple processors, where each processor has one or more compute cores. Such systems often include multiple classes of data storage, including private caches, shared caches, and main memory. Private caches are termed as such because each processor has its own private cache, which is not accessed by the other processors in the system. Shared caches conventionally are larger than private caches, but are shared by multiple (or all) of the processors in the system. Such a shared cache is conventionally divided into many portions that are distributed across the system interconnect. Main memory conventionally is the largest unit of storage, and may be accessed by all processors in the system.

Conventionally, when a processor requests data, the system attempts to service the request using the private cache first. If the request misses in the private cache (e.g., the data is not present in the private cache), the system then checks the shared cache. If the request misses in the shared cache, the request is forwarded to main memory, where the request is serviced and the requested data is sent to the processor. However, many data requests miss in all caches (private and shared), and get serviced by main memory. Such requests spend many tens of cycles traversing through the caches before the request reaches main memory. As such, system performance slows while the processor waits for the data request to be serviced.

### SUMMARY

Aspects disclosed herein relate to expediting cache misses in a shared cache using cache hit prediction.

In one aspect, a method comprises determining that a request to access data at a first physical address misses in a private cache of a processor. The method further comprises determining that a confidence value received for the first physical address based on a hash value of the first physical address exceeds a threshold value. The method further comprises issuing a speculative read request specifying the first physical address to a memory controller of a main memory to expedite a miss for the data at the first physical address in a shared cache.

In one aspect, a non-transitory computer-readable medium stores instructions that, when executed by a processor, cause the processor to perform an operation comprising determining that a request to access data at a first physical address misses in a private cache of a processor. The operation further comprises determining that a confidence value received for the first physical address based on a hash value of the first physical address exceeds a threshold value. The operation further comprises issuing a speculative read request specifying the first physical address to a memory controller of a main memory to expedite a miss for the data at the first physical address in a shared cache.

In one aspect, an apparatus comprises a plurality of computer processors, each processor comprising a respective private cache. The apparatus further comprises a shared cache shared by at least two of the processors and a main memory. The apparatus further comprises logic configured to perform an operation comprising determining that a request to access data at a first physical address misses in a private cache of a first processor of the plurality of processors. The operation further comprises determining that a confidence value received for the first physical address based on a hash value of the first physical address exceeds a threshold value. The operation further comprises issuing a speculative read request specifying the first physical address to a memory controller of a main memory to expedite a miss for the data at the first physical address in a shared cache.

In one aspect, an apparatus comprises a processor comprising a private cache, a shared cache, and a main memory. The apparatus further comprises means for determining that a request to access data at a first physical address misses in the private cache of the processor. The apparatus further comprises means for determining that a confidence value received for the first physical address based on a hash value of the first physical address exceeds a threshold value. The apparatus further comprises means for issuing a speculative read request specifying the first physical address to a memory controller of the main memory to expedite a miss for the data at the first physical address in the shared cache.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIG. 1 illustrates a processing system which expedites cache misses using cache hit prediction, according to one aspect.

FIG. 2 illustrates an example prediction table, according to one aspect.

FIGS. 3A-3C illustrate example sequences of events for expediting cache misses using cache hit prediction, according to various aspects.

FIG. 4 is a flow chart illustrating an example method to expedite cache misses using cache hit prediction, according to one aspect.

FIG. 5 is a flow chart illustrating an example method to determine a confidence value received for a first physical memory address based on a hash value of the first physical memory address exceeds a threshold value, according to one aspect.

FIG. 6 is a flow chart illustrating an example method to issue a speculative read request specifying a first physical memory address to a controller of a main memory, according to one aspect.

FIG. 7 is a flow chart illustrating an example method to update a confidence value based on a private cache miss resolving, according to one aspect.

FIG. 8 is a block diagram illustrating a computing device integrating a cache hit predictor which expedites cache misses using cache hit prediction, according to one aspect.

### DETAILED DESCRIPTION

Aspects disclosed herein expedite cache misses in a shared cache by employing cache hit prediction. Generally, aspects disclosed herein predict whether a data request that has missed in a private cache will be served by the shared cache. The prediction is based on a confidence value associated with a hash value computed for a physical memory address specified by the data request. If the confidence value exceeds a threshold, aspects disclosed herein predict that the data request will not be served by the shared cache, and issue a speculative read request to a memory controller which controls a main memory. The speculative request may be issued in addition to a demand request for the data in the shared cache. If the demand request for the data misses in the shared cache, the demand request is forwarded to the memory controller, where the demand request and the speculative request merge. The merged request is then serviced by main memory, such that the requested data is brought to the private cache. Doing so resolves the cache miss in the private shared cache in less time than would conventionally be required.

Furthermore, aspects disclosed herein provide a training mechanism to reflect the accuracy of previous predictions. Generally, if the main memory provides the requested data, the prediction that the request will miss in the shared cache is determined to be correct, and the confidence value for the physical memory address is incremented. However, if the demand request is not served by main memory (e.g., the demand request is served by the shared cache), the confidence value for the physical memory address is decremented. Doing so improves subsequent predictions for the respective physical memory address.

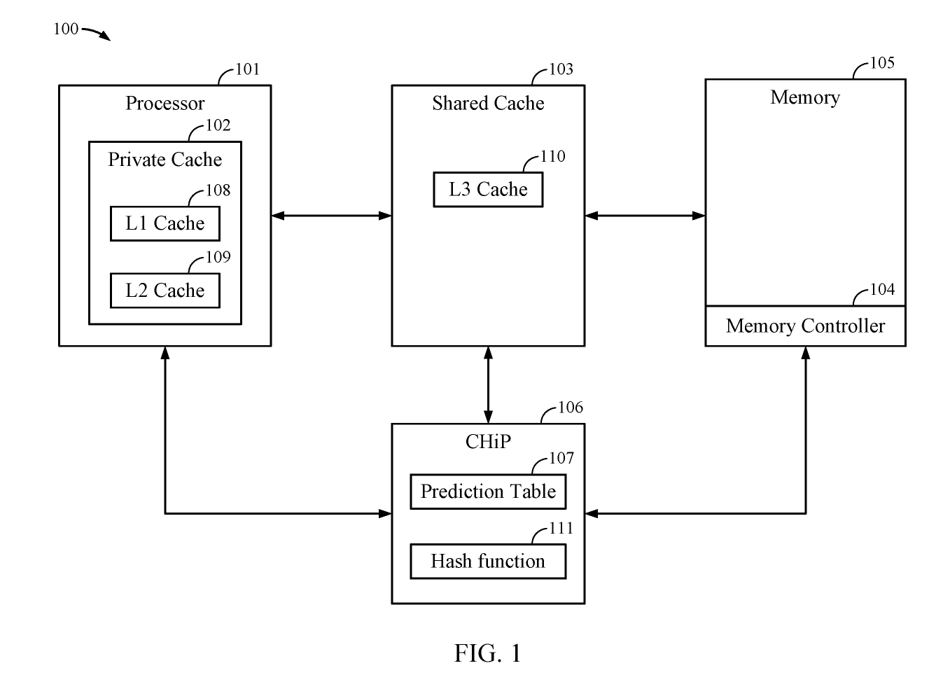

FIG. 1 illustrates a processing system 100 which expedites cache misses using cache hit prediction, according to one aspect. As shown, the processing system 100 includes one or more processors 101, a shared cache 103, a memory controller 104, a memory 105, and a cache hit predictor (CHiP) 106. Processor 101 may be a central processing unit (CPU) or any processor core in general. Processor 101 may be configured to execute program instructions in an instruction execution pipeline (not pictured). As shown, the processor 101 includes an inner cache 102, which comprises a Level 1 (L1) cache 108 and a Level 2 (L2) cache 109. As shown, the shared cache 103 comprises a Level 3 (L3) cache 110. Generally, a cache is a hardware structure that stores lines of data so future requests for the data can be served faster. Each of the caches 108-110 may be an instruction cache, a data cache, or a combination thereof.

The memory controller 104 manages the flow of data to and from the memory 105. Memory 105 may comprise physical memory in a physical address space. A memory management unit (not pictured) may be used to obtain translations of virtual addresses (e.g., from processor 101) to physical addresses for accessing memory 105. Although the memory 105 may be shared amongst one or more other processors 101 or processing elements, these have not been illustrated, for the sake of simplicity. However, each processor 101 is allocated a respective inner cache 102 comprising an L1 cache 108 and an L2 cache 109. The one or more processors 101 each share at least a portion of the L3 cache 110.

During program execution, the processor 101 first looks for needed data in the caches 102, 103. More specifically, the processor 101 first looks for data in the L1 cache 108, followed by the L2 cache 109, and then the L3 cache 110. A cache hit represents the case where the needed data resides in the respective cache. Conversely, a cache miss represents the case where the needed data does not reside in the respective cache. A cache miss in one of the caches 108-110 causes a cache controller (not pictured) to issue a demand request for the requested data in the next highest cache. If the needed data is not resident in the L3 cache 110, the request is served by the memory 105. When the needed data is brought to one or more of the caches 108-110, the cache miss is said to resolve.

The CHiP 106 is a hardware structure configured to expedite cache misses using cache hit prediction. As shown, the CHiP 106 includes a prediction table 107 and a hash function 111. The hash function 111 may be any type of hash function. Generally, a hash function is any function that can be used to map data of arbitrary size to data of fixed size (e.g., a physical memory address to a hash value). The prediction table 107 is an N-entry structure which is indexed by a hash value produced by applying the hash function 111 to a physical memory address. Although the prediction table 107 may be of any size, in one aspect, the prediction table 107 includes 256 entries. Although depicted as being a separate component of the processor 101 for the sake of clarity, in at least one aspect, the CHiP 106 is disposed on an integrated circuit including the processor 101 and the caches 108, 109.

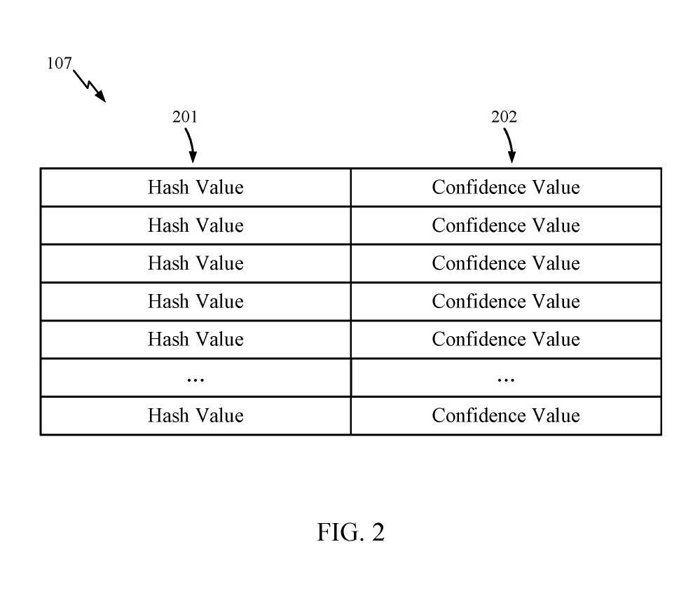

FIG. 2 depicts an example prediction table 107 in greater detail. As shown in FIG. 2, each entry of the prediction table 107 specifies a respective hash value 201 and confidence value 202. In at least one aspect, the hash value 201 is computed based on the physical address of a block of memory 105. In other aspects, the hash value 201 is computed based on the physical address of a region of the memory 105. The confidence value 202 reflects whether previous attempts to access data stored at the corresponding physical memory address was served by the memory 105 or the L3 cache 110. The confidence value 202 is an N-bit counter value. Although the confidence value 202 may be of any size, in one aspect, the confidence value 202 is a 2-bit counter value. In at least one aspect, the confidence values 202 are initialized to an initial value of zero.

In operation, the CHiP 106 determines that a request for data misses in the private caches 102 (e.g., a miss in the L1 cache 108, followed by a miss in the L2 cache 109). When the CHiP 106 determines that the request misses in the L2 cache, the CHiP 106 applies the hash function 111 to the physical memory address specified by the request. If there is a hit in on a hash value 201 in the prediction table 107 (e.g., the hash value produced by the hash function 111 exists in the prediction table 107), the CHiP 106 determines whether the associated confidence value 202 exceeds a threshold value. If the confidence value 202 exceeds the threshold value, the CHiP 106 issues a speculative read request specifying the physical address to the memory controller 104. The threshold value may be any value in a range of values supported by the N-bit confidence values 202. However, in one aspect, the confidence value is zero.

As previously indicated, when the request misses in the L2 cache 109, a demand request for the data is issued to the L3 cache. If the demand request misses in the L3 cache, the demand request is forwarded to the memory controller 104. However, because the speculative request is received by the memory controller 104 prior to the demand request, the demand request merges with the speculative request when received by the memory controller 104. In at least one aspect, merging the speculative and demand requests comprises changing a status of the speculative request to a demand request. The memory controller 104 then processes the merged request, and the data is brought to the L1 cache 108 and/or the L2 cache 109. Doing so allows the miss in the private cache 102 to resolve faster than waiting for the demand request to be served by the memory controller 104 after missing in the L3 cache 110.

The prediction table 107 is depicted as a tagged structure in FIG. 2. However, in some aspects, the prediction table 107 is not a tagged structure. In such aspects, the hash value 201 is used to index the prediction table 107, and the corresponding confidence value 202 is returned to the CHiP 106. Furthermore, for write operations in such aspects, the hash value 201 is used to index the prediction table 107, and a confidence value 202 is written to the corresponding entry in the prediction table 107. Therefore, in such aspects, tag matching is not needed to read and/or write confidence values 202 in the prediction table 107.

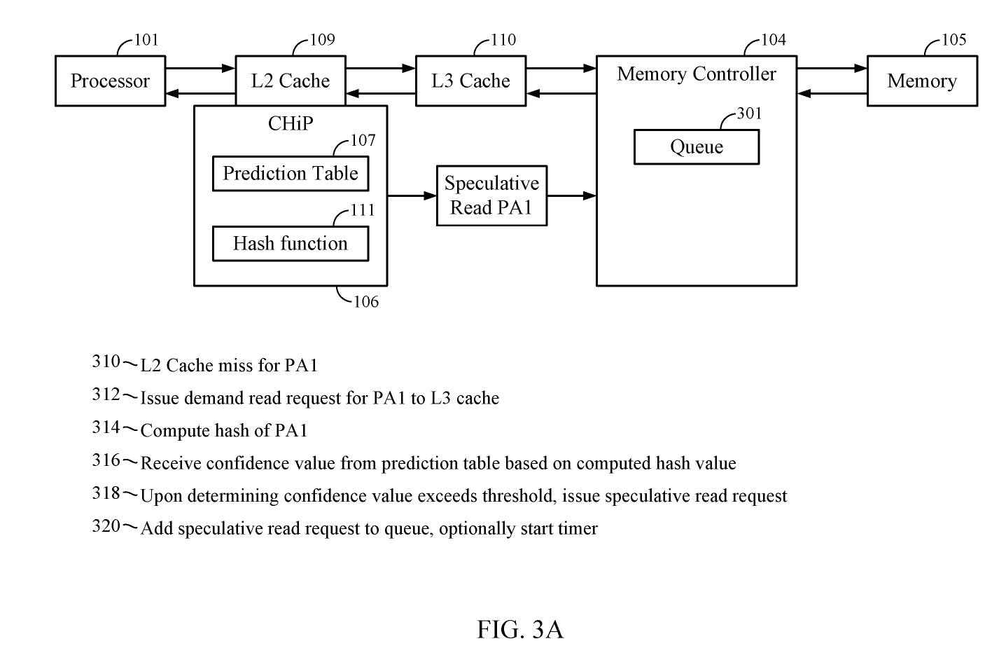

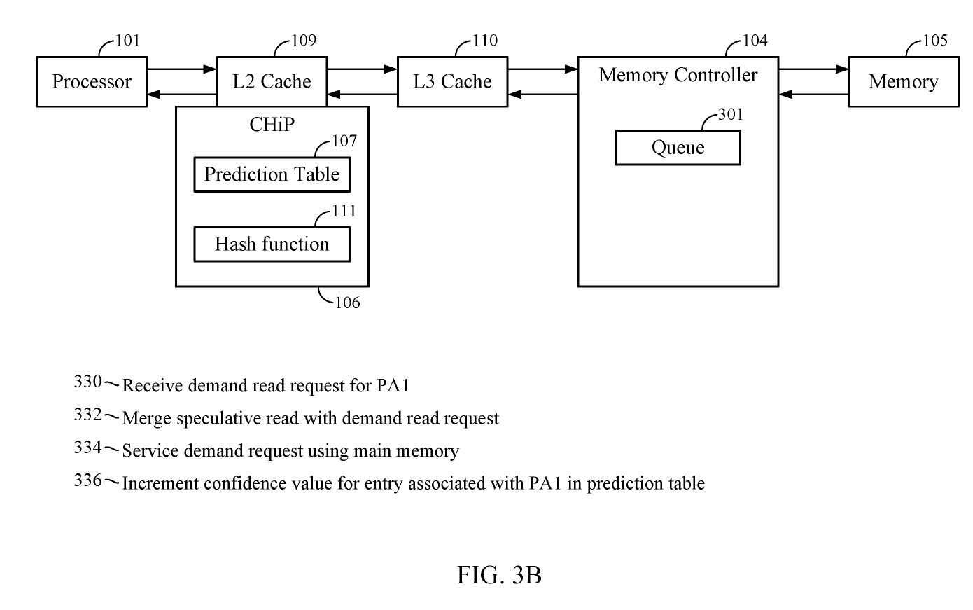

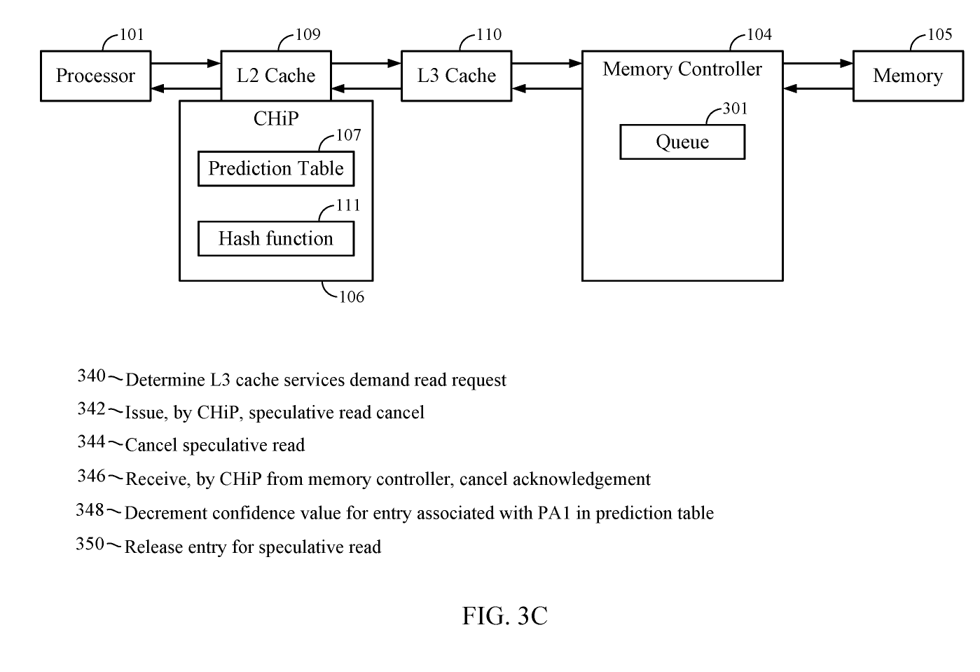

FIG. 3A illustrates an example sequence of events for expediting cache misses using cache hit prediction, according to one aspect. As shown, at event 310, a request to access data stored at an example physical address of “PA1” misses in the L2 cache 109. At event 312, the processor 101 and/or cache controller issues a demand read request for PA1 to the L3 cache 110. At event 314, which may occur contemporaneously with event 312, the CHiP 106 computes a hash value for PA1 by applying the hash function 111 to PA1. At event 316, the CHiP 106 references the prediction table 107 using the hash value computed for PA1. A hit in the prediction table 107 returns a confidence value 202 for the entry corresponding to the hash value 201 that matches the hash value computed for PA1. At event 318, the CHiP 106 determines that the received confidence value 202 exceeds threshold value. As such, the CHiP 106 predicts that the demand request for PA1 will miss in the L3 cache 110. Therefore, the CHiP 106 generates and issues a speculative read request for PA1 to the memory controller 104. At event 320, the memory controller 104 adds the received speculative read request to the queue 301. The queue 301 is a queue for serving read requests. In at least one aspect, the queue 301 and/or memory controller 104 is configured to differentiate between speculative and demand queues (e.g., via an indicator bit, a status register, etc.). In some aspects, the memory controller 104 includes separate queues for speculative and demand read requests. In such aspects, if the speculative read queue is full, the memory controller 104 may silently drop the speculative read request received from the CHiP 106. Furthermore, in at least one aspect, the memory controller 104 optionally starts a timer to support a timeout mechanism described in greater detail below.

FIG. 3B depicts an example sequence of events after the demand read request for PA1 issued at event 312 misses in the L3 cache 110. The miss in the L3 cache causes a demand read request to be issued to the memory controller 104. At event 330, the memory controller 104 receives the demand request for PA1. Because the speculative read request is issued contemporaneously with the demand read request to the L3 cache 110 at event 312, the speculative read request arrives at the memory controller 104 before the demand read request (e.g., before event 320). The memory controller 104 may compare the physical address specified in the demand read request (e.g., PA1) to the physical addresses associated with the speculative reads stored in the queue 301. Because the physical address of PA1 is specified in the speculative request for PA1 stored in the queue 301, at event 332, the memory controller 104 merges the demand and speculative read requests for PA1 into a single request. In one aspect, the merging comprises converting the speculative request into a demand request. In another aspect, where the memory controller 104 maintains separate queues for speculative and demand reads, the memory controller 104 adds the demand request to the demand queue based on the priority of the speculative read in the speculative queue, and the entry for the speculative read is released from the speculative queue. Regardless of the merging technique, the merging causes the demand request for PA1 to acquire the higher relative priority of the speculative request for PA1.

At event 334, the memory controller 104 services the merged request using the main memory 105. Doing so transfers the data stored at PA1 to the L2 cache 109 (and/or the L1 cache 108), and resolves the initial miss for PA1 incurred at event 310. At event 336, the CHiP 106 increments the confidence value 202 of the entry associated with the hash value generated for PA1 in the prediction table 107. Doing so reflects that the prediction that PA1 will miss in the L3 cache 110 was correct, and allows the CHiP 106 to make future predictions that PA1 will miss in the L3 cache 110 with greater confidence.

FIG. 3C depicts a sequence of events following the events in FIG. 3A, where the L3 cache 110, and not the memory 105, resolves the cache miss for PA1 in the L2 cache 109. As shown, at event 340, the CHiP 106 determines that the L3 cache 110 services the demand request for the data at PA1. Stated differently, a cache hit occurs for PA1 in the L3 cache 110 at event 340. In response, the CHiP 106 issues a speculative read cancel instruction to the memory controller 104 at event 342. The speculative read cancel instruction is an indication specifying, to the memory controller 104, to cancel the speculative read for PA1. At event 344, the memory controller 104 receives the speculative read cancel, which specifies to cancel PA1. The memory controller 104 then determines that a speculative read request for PA1 exists in the queue 301, and cancels the speculative read for PA1 (e.g., the memory controller 104 drops or removes the indication of the speculative read for PA1 from the queue 301). The memory controller 104 also sends an acknowledgement of the speculative read cancel to the CHiP 106. In at least one aspect, if the memory controller 104 was in the process of reading data from PA1 in the memory 105, the memory controller 104 discards the read data when cancelling the speculative read. As previously indicated, in some aspects, the memory controller 104 implements a timeout mechanism to cancel a speculative read. In such aspects, if the timer initiated at event 320 exceeds a threshold and the memory controller 104 has not received a demand request for PA1 following a miss for PA1 in the L3 cache 110, the memory controller 104 may cancel the speculative read. In such aspects, if the memory controller 104 may drop any received data from PA1 of the memory 105 when cancelling the speculative read.

At event 346, the CHiP 106 receives the cancel acknowledgement from the memory controller 104. At event 348, the CHiP 106 decrements the confidence value 202 for the entry associated with the hash of PA1 in the prediction table 107. The CHiP 106 decrements the confidence value 202 to reflect that the prediction that PA1 would miss in the L3 cache 110 was incorrect. In at least one aspect, however, the CHiP 106 resets the confidence value 202 to zero rather than decrementing the confidence value 202. Doing so may prevent the CHiP 106 from issuing excessive speculative reads to the memory controller 104. At event 350, the CHiP 106 and/or the cache controller releases an entry reflecting the miss in the L2 cache for PA1 (e.g., in a miss status holding register (MSHR), and/or an outgoing request buffer).

More generally, in some aspects, the CHiP 106 may optionally modify the threshold value applied to the confidence values 202. For example, if a computed average of the confidence values 202 in the prediction table 107 increases over time, the CHiP 106 may increase the threshold to reduce the number of speculative reads issued to the memory controller 104. Similarly, if the average of the confidence values 202 decreases over time, the CHiP 106 may decrease the threshold to expedite more misses in the L3 cache 110.

Means for storing data in the caches 108-110, memory 104, CHiP 106, prediction table 107, and queue 301 include one or more memory cells. Means for searching and modifying data stored in the caches 108-110, memory 104, CHiP 106, prediction table 107, and queue 301 include logic implemented as hardware and/or software. Similarly, the logic implemented as hardware and/or software may serve as means for reading and/or writing values, returning indications of hits and/or misses, evicting entries, and returning values from the caches 108-110, memory 104, CHiP 106, prediction table 107, and queue 301. Example of such means logic includes memory controllers (e.g., the memory controller 104), cache controllers, and data controllers.

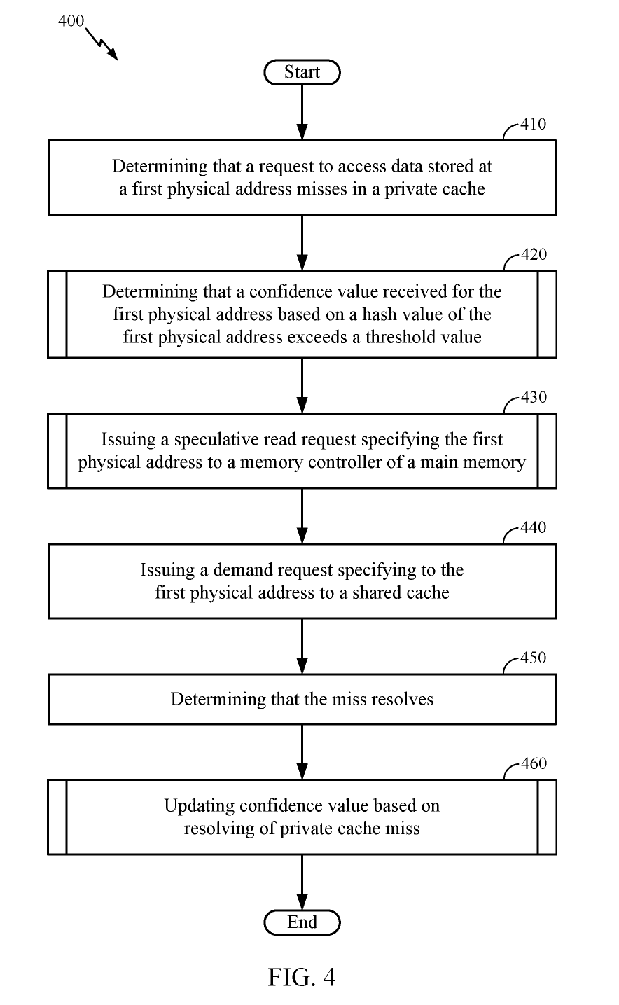

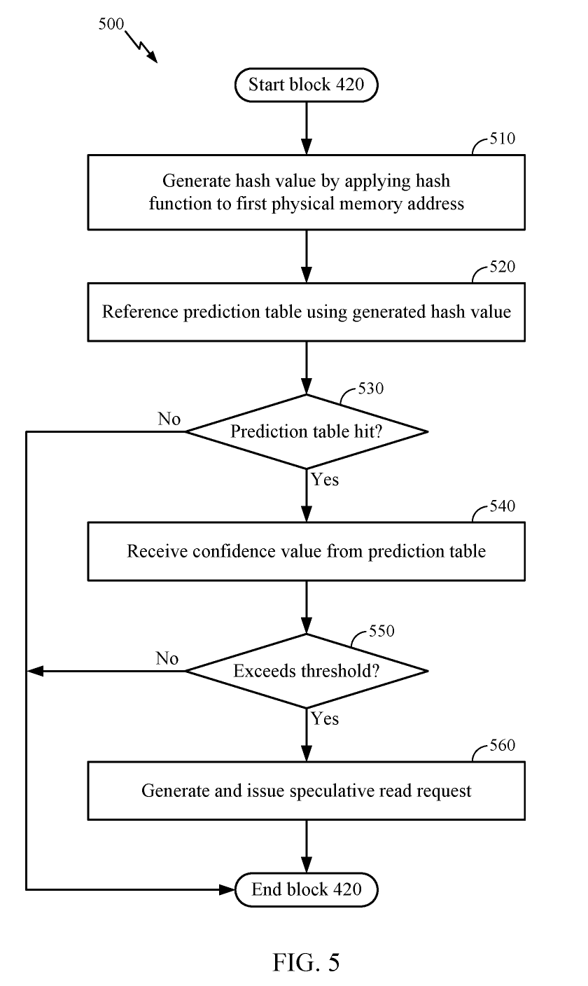

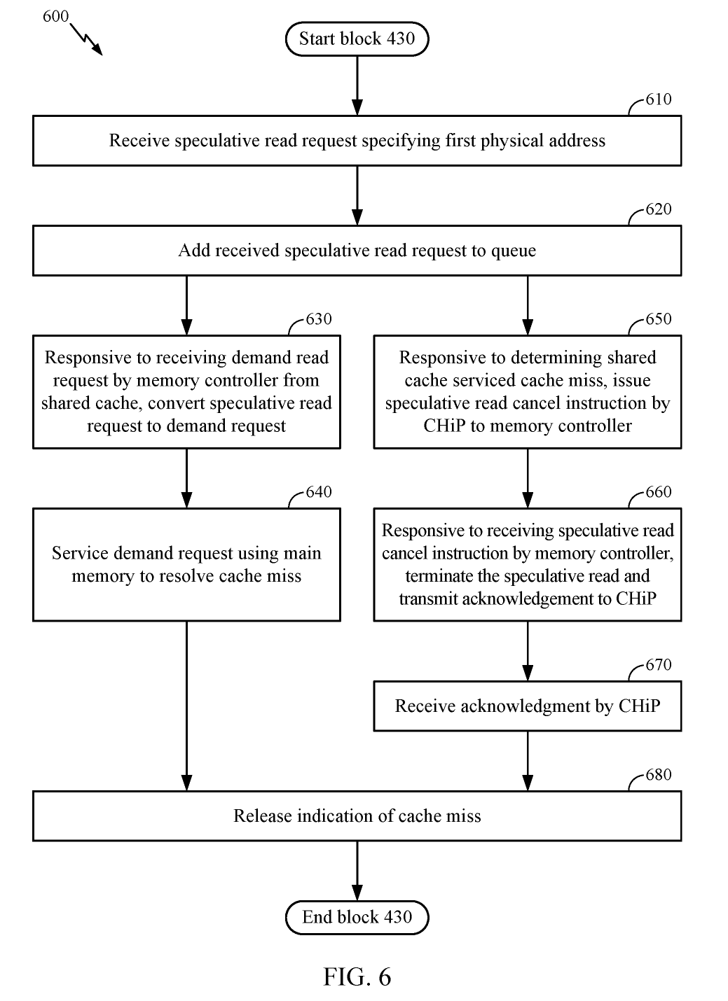

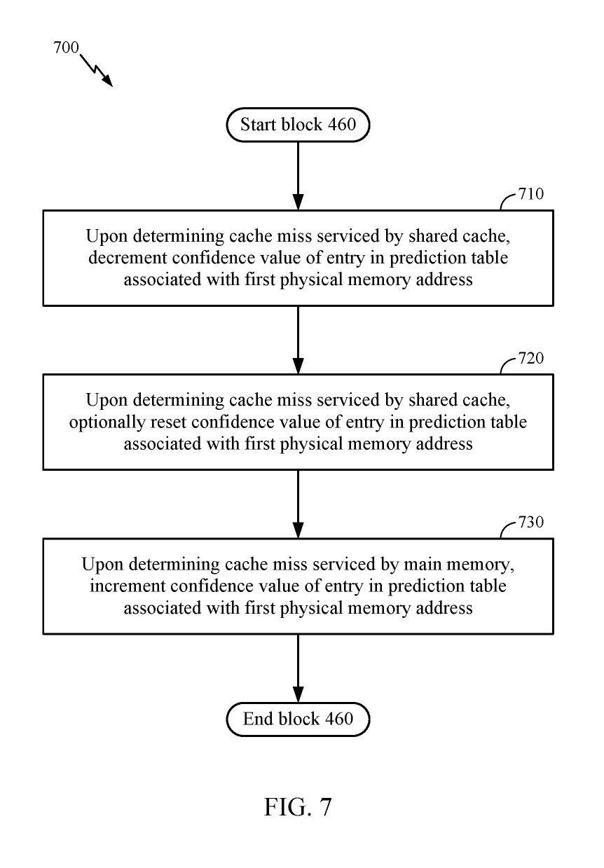

FIG. 4 is a flow chart illustrating an example method 400 to expedite cache misses using cache hit prediction, according to one aspect. As shown, the method 400 includes block 410, where the CHiP 106 determines that a request to access data stored at a first physical memory address misses in a private cache 102, namely the L2 cache 109. At block 420, described in greater detail with reference to FIG. 5, the CHiP 106 determines that a confidence value 202 received from the prediction table 107 for the first physical address exceeds a threshold. As previously stated, the CHiP 106 receives the confidence value 202 based on a hash value generated by applying a hash function 111 to the first physical address. At block 430, described in greater detail with reference to FIG. 6, the CHiP 106 issues a speculative read request specifying the first physical address to the memory controller 104 of the memory 105. At block 440, a demand request specifying the first physical address is issued to a shared cache 103 (e.g., the L3 cache 110). Although depicted as occurring subsequent to block 430, the performance of blocks 430 and 440 may occur in any order and/or contemporaneously. At block 450, the CHiP 106 determines that the miss incurred at block 450 resolves. Generally, the miss resolves by bringing the requested data to the L2 cache from the L3 cache 110 or the memory 105. At block 460, described in greater detail with reference to FIG. 7, the CHiP 106 updates the confidence value 202 received at block 420 based on the miss in the L2 cache 109 resolving at block 450. Generally, if the miss is serviced by the L3 cache 110, the confidence value 202 is decremented and/or reset. If the miss is serviced by the memory 105, the confidence value 202 is incremented. Doing so allows the CHiP 106 to dynamically adjust the confidence values 202 in the prediction table 107 based on whether the predictions made by the CHiP 106 were correct or incorrect, which improves subsequent predictions made by the CHiP 106.

FIG. 5 is a flow chart illustrating an example method 500 corresponding to block 420 to determine a confidence value received for a first physical memory address based on a hash value of the first physical memory address exceeds a threshold value, according to one aspect. As shown, the method 510 includes block 510, where the CHiP 106 generates a hash value for the first physical memory address that missed in the L2 cache 109 at block 410. As previously stated, the hash value is computed by applying a hash function 111 to the first physical memory address. At block 520, the CHiP 106 references the prediction table 107 using the hash value generated at block 510. At block 530, the CHiP 106 determines whether a hit was incurred for the generated hash value in the prediction table 107. If a hit was not incurred (e.g., a hash value 201 in the prediction table 107 does not match the hash value computed at block 510), the CHiP 106 does not issue a speculative read request. If a hit is incurred, the CHiP 106 receives the associated confidence value 202 from the entry that hit in the prediction table 107. At block 550, the CHiP 106 determines whether the received confidence value 202 exceeds a confidence threshold. If the received confidence value 202 exceeds the confidence threshold, the CHiP 106 generates and issues the speculative read request for the first physical address at block 560, which is sent to the memory controller 104. If the confidence value 202 does not exceed the threshold, the CHiP 106 determines to forego issuing a speculative read request.

FIG. 6 is a flow chart illustrating an example method 600 corresponding to block 430 to issue a speculative read request specifying a first physical memory address to a controller of a main memory, according to one aspect. As shown, the method 600 includes block 610, where the memory controller 104 receives the speculative read request specifying the first physical address from the CHiP 106. At block 620, the memory controller 104 adds an indication of the speculative read request for the first physical address to the queue 301. At block 630, the memory controller 104 converts the speculative read request received at block 610 to a demand request responsive to receiving a demand request for the first physical address (e.g., after a miss for the first physical address in the L3 cache 110). At block 640, the memory controller 104 services the converted demand request using the main memory 105 to resolve the miss in the L2 cache 109 for the data at the first physical address. The method then proceeds to block 680, where the CHiP 106 releases an indication of the initial miss in the L2 cache 109 (e.g. from an MSHR or outbound cache miss queue).

Returning to block 620, the L3 cache 110 may store the needed data. In such aspects, the method 600 proceeds to block 650, where the CHiP 106 determines that the L3 cache 110 serviced the cache miss (e.g., the data associated with the first physical address was present in the L3 cache 110 and was brought to the L2 cache 109). In response, the CHiP 106 issues a speculative read cancel instruction for the first physical address to the memory controller 104. At block 660, the memory controller 104 receives the speculative read cancel instruction from the CHiP 106. In response, the memory controller 104 terminates the speculative read for the first physical memory address (e.g., removes the corresponding entry from the queue 301), and transmits a cancel acknowledgement to the CHiP 106. At block 670, the CHiP 106 receives the cancel acknowledgement from the memory controller 104. At block 680 the CHiP 106 releases an indication of the initial miss in the L2 cache 109.

FIG. 7 is a flow chart illustrating an example method 700 corresponding to block 460 to update a confidence value 220 in the prediction table 107 based on the miss in the private cache 102 resolving, according to one aspect. As shown, the method 700 includes block 710, where the CHiP 106 decrements the confidence value 202 associated with the hash value 201 of the first physical address in the prediction table 107 upon determining that the miss in the L2 cache 109 was serviced by the shared cache 103 (e.g., the L3 cache 110). At block 720, the CHiP 106 optionally resets the confidence value 202 associated with the hash value 201 of the first physical address in the prediction table 107 upon determining that the miss in the L2 cache 109 was serviced by the shared cache 103 (e.g., the L3 cache 110). Doing so may limit the number of subsequent speculative read requests issued by the CHiP 106. At block 730, the CHiP 106 decrements the confidence value 202 associated with the hash value 201 of the first physical address in the prediction table 107 upon determining that the miss in the L2 cache 109 was serviced by the main memory 104. Doing so reflects that the CHiP 106 correctly predicted a miss for the first physical memory address in the L3 cache 110.

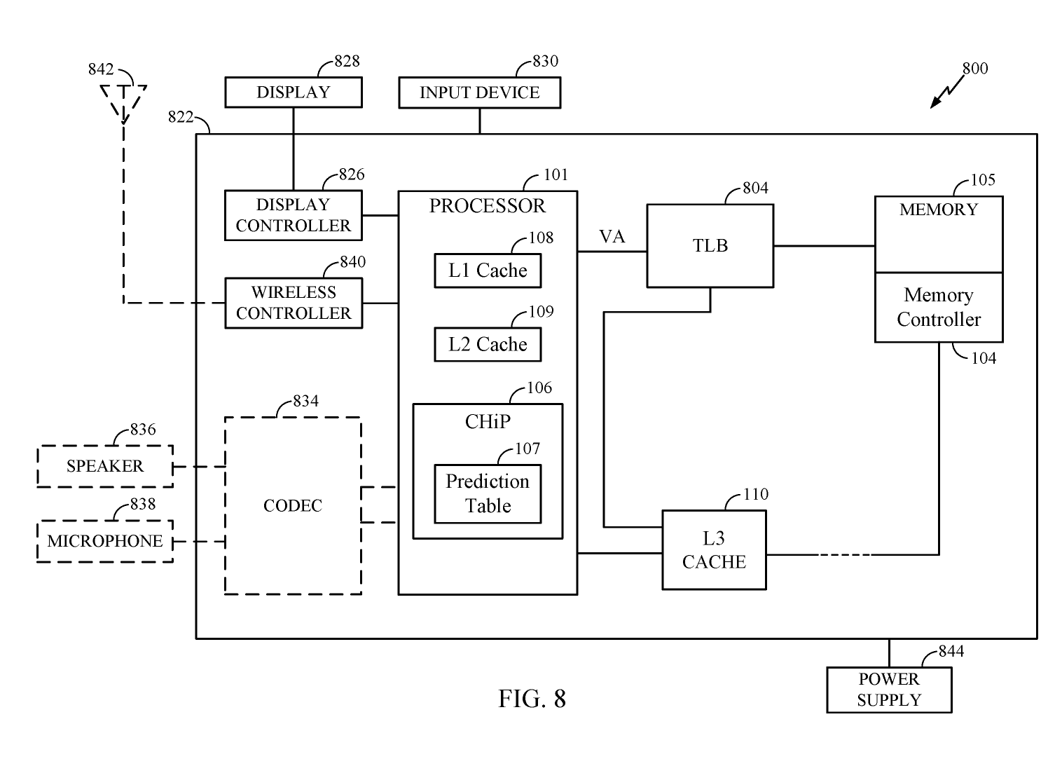

An example apparatus in which exemplary aspects of this disclosure may be utilized is discussed in relation to FIG. 8. FIG. 8 shows a block diagram of computing device 800. Computing device 800 may correspond to an exemplary implementation of a processing system configured to implement all apparatuses, logic, and methods discussed above with reference to FIGS. 1-7. In the depiction of FIG. 8, computing device 800 includes processor 101, CHiP 106, prediction table 107, caches 108-110, memory controller 104, memory 105, and a translation lookaside buffer (TLB) 804. The TLB 804 is part of a memory management unit (not pictured) which is used to obtain translations of virtual addresses to physical addresses for accessing the caches 108-110 and/or the memory 105.

FIG. 8 also shows display controller 826 that is coupled to processor 101 and to display 828. In some cases, computing device 800 may be used for wireless communication and FIG. 8 also shows optional blocks in dashed lines, such as coder/decoder (CODEC) 834 (e.g., an audio and/or voice CODEC) coupled to processor 101 and speaker 836 and microphone 838 can be coupled to CODEC 834; and wireless antenna 842 coupled to wireless controller 840 which is coupled to processor 101. Where one or more of these optional blocks are present, in a particular aspect, processor 101, CHiP 106, prediction table 107, caches 108-110, display controller 826, memory controller 104, memory 105, and wireless controller 840 are included in a system-in-package or system-on-chip device 822.

Accordingly, in a particular aspect, input device 830 and power supply 844 are coupled to the system-on-chip device 822. Moreover, in a particular aspect, as illustrated in FIG. 8, where one or more optional blocks are present, display 828, input device 830, speaker 836, microphone 838, wireless antenna 842, and power supply 844 are external to the system-on-chip device 822. However, each of display 828, input device 830, speaker 836, microphone 838, wireless antenna 842, and power supply 844 can be coupled to a component of the system-on-chip device 822, such as an interface or a controller.

Although FIG. 8 generally depicts a computing device, processor 101, memory controller 104, memory 105, CHiP 106, prediction table 107, and caches 108-110 may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Advantageously, aspects disclosed herein provide techniques to expedite cache misses in a shared cache using cache hit prediction. Generally, aspects disclosed herein predict whether a request to access data at a first physical address will miss in the shared cache (e.g., the L3 cache 110) after a miss for the data has been incurred at a private cache (e.g., the L2 cache 109). If the prediction is for a miss in the L3 cache 110, aspects disclosed herein expedite the miss in the L3 cache 110 by sending a speculative read request to the memory controller 104. If there is a miss in the L3 cache 110, the memory controller 104 receives a demand request for the first physical address, which merges with the speculative request, giving the demand request a higher relative priority in a read queue.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The various operations of methods described above may be performed by any suitable means capable of performing the operations, such as a processor, firmware, application specific integrated circuit (ASIC), gate logic/registers, memory controller, or a cache controller. Generally, any operations illustrated in the Figures may be performed by corresponding functional means capable of performing the operations.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the processor 101) and packaged, and may be further integrated into products including, but not limited to, mobile phones, smart phones, laptops, netbooks, tablets, ultrabooks, desktop computers, digital video recorders, set-top boxes and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another aspect, the hardware, circuitry, and method described herein may be configured into computer files that simulate the function of the circuits described above and shown in the Figures when executed by a processor. These computer files may be used in circuitry simulation tools, schematic editors, or other software applications.

The implementations of aspects disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such aspects.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method, comprising:
determining that a request to access data at a first physical address misses in a private cache of a processor;
determining that a confidence value received for the first physical address based on a hash value of the first physical address exceeds a threshold value; and
issuing a speculative read request specifying the first physical address to a memory controller of a main memory to expedite a miss for the data at the first physical address in a shared cache.

2. The method of claim 1, wherein the private cache comprises a Level 2 (L2) cache, wherein the shared cache comprises a Level 3 (L3) cache, the method further comprising:
issuing a demand request for the data at the first physical address to the L3 cache;
receiving, by the memory controller, the speculative read request; and
creating, by the memory controller, an indication of the speculative read request in a queue.

3. The method of claim 2, further comprising:
determining that the demand request misses in the L3 cache;
receiving, by the memory controller, the demand request for the data at the first physical address;
converting the speculative read request to a converted demand request in the queue, wherein the converted demand request maintains a priority of the speculative read request in the queue; and
servicing the converted demand request using the main memory.

4. The method of claim 3, further comprising:
incrementing the confidence value based on the main memory servicing the converted demand request.

5. The method of claim 2, further comprising:
determining that the demand request hits in the L3 cache;
issuing a speculative read cancel specifying to first physical address to the memory controller; and
removing, by the memory controller, the indication of the speculative read request from the queue responsive to receiving the speculative read cancel.

6. The method of claim 5, further comprising:
decrementing the confidence value based on the determining that the demand request hits in the L3 cache.

7. The method of claim 1, wherein determining that the confidence value received for the first physical address of the first physical address exceeds the threshold value comprises:
computing the hash value by applying a hash function to the first physical memory address;
referencing a prediction table using the computed hash value;
determining that the computed hash value hits on a hash value of a first entry of the prediction table; and
receiving the confidence value from the first entry of the prediction table.

8. A non-transitory computer-readable medium storing instructions that, when executed by a processor, cause the processor to perform an operation comprising:
determining that a request to access data at a first physical address misses in a private cache of a processor;
determining that a confidence value received for the first physical address based on a hash value of the first physical address exceeds a threshold value; and
issuing a speculative read request specifying the first physical address to a memory controller of a main memory to expedite a miss for the data at the first physical address in a shared cache.

9. The non-transitory computer-readable medium of claim 8, wherein the private cache comprises a Level 2 (L2) cache, wherein the shared cache comprises a Level 3 (L3) cache, the operation further comprising:
issuing a demand request for the data at the first physical address to the L3 cache;
receiving, by the memory controller, the speculative read request; and
storing, by the memory controller, an indication of the speculative read request in a queue.

10. The non-transitory computer-readable medium of claim 9, the operation further comprising:
determining that the demand request misses in the L3 cache;
receiving, by the memory controller, the demand request for the data at the first physical address;
converting the speculative read request to a converted demand request in the queue, wherein the converted demand request maintains a priority of the speculative read request in the queue; and servicing the converted demand request using the main memory.

11. The non-transitory computer-readable medium of claim 10, the operation further comprising:
incrementing the confidence value based on the main memory servicing the converted demand request.

12. The non-transitory computer-readable medium of claim 9, the operation further comprising:
determining that the demand request hits in the L3 cache;
issuing a speculative read cancel specifying to first physical address to the memory controller; and
removing, by the memory controller, the indication of the speculative read request from the queue responsive to receiving the speculative read cancel.

13. The non-transitory computer-readable medium of claim 12, the operation further comprising:
decrementing the confidence value based on the determining that the demand request hits in the L3 cache.

14. The non-transitory computer-readable medium of claim 8, wherein determining that the confidence value received for the first physical address of the first physical address exceeds the threshold value comprises:
computing the hash value by applying a hash function to the first physical memory address;
referencing a prediction table using the computed hash value;
determining that the computed hash value hits on a hash value of a first entry of the prediction table; and
receiving the confidence value from the first entry of the prediction table.

15. An apparatus, comprising:
a plurality of computer processors, each processor comprising a respective private cache;
a shared cache shared by at least two of the processors;
a main memory; and
logic configured to perform an operation comprising:
determining that a request to access data at a first physical address misses in a private cache of a first processor of the plurality of processors;
determining that a confidence value received for the first physical address based on a hash value of the first physical address exceeds a threshold value; and
issuing a speculative read request specifying the first physical address to a memory controller of the main memory to expedite a miss for the data at the first physical address in the shared cache.

16. The apparatus of claim 15, wherein the private cache comprises a Level 2 (L2) cache, wherein the shared cache comprises a Level 3 (L3) cache, the operation further comprising:
issuing a demand request for the data at the first physical address to the L3 cache;
receiving, by the memory controller, the speculative read request; and
storing, by the memory controller, an indication of the speculative read request in a queue.

17. The apparatus of claim 16, the operation further comprising:
determining that the demand request misses in the L3 cache;
receiving, by the memory controller, the demand request for the data at the first physical address;
converting the speculative read request to a converted demand request in the queue, wherein the converted demand request maintains a priority of the speculative read request in the queue; and
servicing the converted demand request using the main memory.

18. The apparatus of claim 17, the operation further comprising:
incrementing the confidence value based on the main memory servicing the converted demand request.

19. The apparatus of claim 16, the operation further comprising:
determining that the demand request hits in the L3 cache;
issuing a speculative read cancel specifying to first physical address to the memory controller; and
removing, by the memory controller, the indication of the speculative read request from the queue responsive to receiving the speculative read cancel.

20. The apparatus of claim 19, the operation further comprising:
decrementing the confidence value based on the determining that the demand request hits in the L3 cache.

21. The apparatus of claim 15, wherein determining that the confidence value received for the first physical address of the first physical address exceeds the threshold value comprises:
computing the hash value by applying a hash function to the first physical memory address;
referencing a prediction table using the computed hash value;
determining that the computed hash value hits on a hash value of a first entry of the prediction table; and
receiving the confidence value from the first entry of the prediction table.

22. An apparatus, comprising:
a processor comprising a private cache;
a shared cache;
a main memory;
means for determining that a request to access data at a first physical address misses in the private cache of the processor;
means for determining that a confidence value received for the first physical address based on a hash value of the first physical address exceeds a threshold value; and
means for issuing a speculative read request specifying the first physical address to a memory controller of the main memory to expedite a miss for the data at the first physical address in the shared cache.

23. The apparatus of claim 22, wherein the private cache comprises a Level 2 (L2) cache, wherein the shared cache comprises a Level 3 (L3) cache, the apparatus further comprising:
means for issuing a demand request for the data at the first physical address to the L3 cache;
means for receiving, by the memory controller, the speculative read request; and
means for storing, by the memory controller, an indication of the speculative read request in a queue.

24. The apparatus of claim 23, further comprising:
means for determining that the demand request misses in the L3 cache;
means for receiving, by the memory controller, the demand request for the data at the first physical address;
means for converting the speculative read request to a converted demand request in the queue, wherein the converted demand request maintains a priority of the speculative read request in the queue; and
means for servicing the converted demand request using the main memory.

25. The apparatus of claim 24, further comprising:
means for incrementing the confidence value based on the main memory servicing the converted demand request.

26. The apparatus of claim 22, further comprising:
means for determining that the demand request hits in the L3 cache;
means for issuing a speculative read cancel specifying to first physical address to the memory controller; and
means for removing, by the memory controller, the indication of the speculative read request from the queue responsive to receiving the speculative read cancel.

27. The apparatus of claim 26, further comprising:
means for decrementing the confidence value based on the determining that the demand request hits in the L3 cache.

28. The apparatus of claim 22, wherein the means for determining that the confidence value received for the first physical address of the first physical address exceeds the threshold value comprises:
means for computing the hash value by applying a hash function to the first physical memory address;
means for referencing a prediction table using the computed hash value;
means for determining that the computed hash value hits on a hash value of a first entry of the prediction table; and
means for receiving the confidence value from the first entry of the prediction table.
